(19) United States
(12) Patent Application Publication
(10) Pub. No.: US 2014/0265474 A1
(43) Pub. Date: Sep. 18, 2014

(54) SEAT RECLINER WITH BREAKAWAY CONNECTOR ROD

(71) Applicant: LEAR CORPORATION, Southfield, MI (US)

(72) Inventor: Peter R. MCCULLOCH, Grosse Pointe Woods, MI (US)

(73) Assignee: LEAR CORPORATION, Southfield, MI (US)

(21) Appl. No.: 14/198,654

(22) Filed: Mar. 6, 2014

Related U.S. Application Data
(60) Provisional application No. 61/787,119, filed on Mar. 15, 2013.

(51) Int. Cl. B60N 2/42

(52) U.S. Cl. CPC B60N 2/4228
USPC 297/216.14

(57) ABSTRACT

A recliner assembly for a vehicle seat, and the associated seat, is provided with seat back, a seat base, and a hinge that connects the seat back to the seat base, wherein the hinge includes a recliner assembly having a pair of recliner mechanisms that are disposed on opposite sides of the seat, and which may be shifted between the locked position and an unlocked position by manually pivoting a connector rod that operatively joins each of the recliner mechanisms. The connector rod is operably, but not directly, connected to at least one of the recliner mechanisms through engagement with a hub at a location on the inboard side of the recliner mechanism, which hub is, in turn, engaged with the recliner mechanism. The connector rod may also be indirectly connected to the other of the recliner mechanisms in a like manner.

### CROSS-REFERENCE TO RELATED APPLICATIONS

This application claims the benefit of U.S. provisional application Ser. No. 61/787,119 filed Mar. 15, 2013, the disclosure of which is hereby incorporated in its entirety by reference herein.

### TECHNICAL FIELD

The present invention relates to seat back reclining mechanisms that are paired on opposite sides of a seat back and joined by a connecting rod, and seats including such mechanisms.

### BACKGROUND

Vehicle seats may be provided with tilt adjustment mechanisms that allow a seat back to be retained at a comfortable angle of inclination relative to a seat base. The tilt adjustment (or recliner) mechanisms may be one of a variety of disc-type designs, including a continuous engagement type in which gears having offset centers of rotation are constantly engaged. These continuous engagement type mechanisms may be powered by a bi-directional motor, or they may be configured to be manually adjustable. Another manual disc-type recliner mechanism design, known as a discontinuous mechanism, may have a gear plate in the guide plate that is selectively interlocked by a plurality of locking pawls at selected angular orientation. The pawls may be released and re-engaged to change the angle of the seat back. Examples of continuous and discontinuous disc-type recliner mechanisms are disclosed, respectively, in U.S. Pat. No. 7,878,593 and U.S. Patent Application Publication No. 2012/0086253.

Vehicle seats are often provided with a hinge assembly that connects a seat back to a seat base, wherein the hinge assembly includes a pair of recliner mechanisms that are disposed on opposite sides of the seat, and which may be shifted between a locked position and an unlocked position by manually pivoting a connector rod. One example of this type of paired, connected recliner mechanism assembly is shown in FIG. 1, and is described in greater detail in the above-mentioned Publication No. 2012/0086253. In the embodiment depicted in FIG. 1, a vehicle seat 10 is illustrated that includes a seat back 12 and a seat base 14 that are connected by an inboard recliner 16 and an outboard recliner 18. The inboard recliner 16 and outboard recliner 18 are connected by a recliner release (or connector) rod 20 that is used to coordinate release and locking of the inboard recliner 16 and outboard recliner 18.

FIG. 2 illustrates a typical prior assembly of one of the recliner mechanisms with a connector rod. The connector rod is typically sized and shaped in cross-section to fit through a central opening in the recliner mechanism, and is typically retained in place by a retaining clip or a push nut.

A potential problem is presented, however, if an unexpected sheer force or rotational torque is applied to the connector rod. For example if the vehicle is subjected to a sudden rear impact, the connector rod may deform and in some cases rotate, which may result in the unwanted release of one or both of the recliner mechanisms to which the rod is connected.

Applicant has attempted to resolve the above problem and other problems that may be apparent to one of ordinary skill in the art as summarized below.

### SUMMARY

According to one aspect of the present invention, a vehicle seat is provided with seat back, a seat base, and a hinge assembly that connects the seat back to the seat base, wherein the hinge assembly includes a pair of recliner mechanisms that are disposed on opposite sides of the seat, and which may be shifted between the locked position and an unlocked position by manually pivoting a connector rod that operatively joins each of the recliner mechanisms. The connector rod is operably, but not directly, connected to at least one of the recliner mechanisms through engagement with a hub at a location on the inboard side of the recliner mechanism, which hub is, in turn, engaged with the recliner mechanism. The connector rod may also be indirectly connected to the other of the recliner mechanisms in a like manner.

The connecting rod is engaged with the hub and operably connected to the recliner mechanism as a result of the engagement of the hub with the recliner mechanism. The connector rod can be constrained from lateral movement to prevent the rod end from extending into the outboard portion of the hub (that is, the portion of the hub which extends through the recliner mechanism), either by the addition of a detent, such as a retaining clip, to the connecting rod which limits the extent of engagement of the rod end with the extended hub, or by configuring the cross-sections of the rod end and the opening in the outboard portion of the hub such that the rod end does not fit within the opening in the outboard portion of the hub.

The outboard portion of each hub is configured to be inserted to an opening in one of the recliner mechanisms so that the hub is retained within, and substantially non-rotating with respect to, that portion of the recliner mechanism. In one embodiment, the outboard portion of the hub is substantially non-circular in cross-section and the opening in the recliner is similarly non-circular in cross-section.

The connector rod is configured to be retained within, and non-rotatable with respect to, the inboard portion of the hub. In one embodiment, the rod end also has a substantially non-circular cross-section at each end, and the inboard portion of each of the hubs has an opening defined as a substantially non-circular cross-section similar in shape to, and suitable for accommodating, the end of the connector rod.

With this disclosed configuration, the connector rod will disengage from the hub, either by deforming and pulling away from the inboard portion of the extended hub end, or by causing the hub end to break away, when the vehicle is subjected to a high load impact event (particularly from the rear). Since the connecting rod is now no longer in engagement with the hub (or the recliner mechanism), any unintended rod rotation that may occur as a result of the unexpected load event will not cause the hub to rotate, thereby reducing the possibility of an unintended release of the recliner mechanism(s) to which the connecting rod was otherwise indirectly engaged during normal operation.

According to another aspect of the present invention, a recliner assembly is provided for a vehicle seat having seat back, a seat base, and a hinge assembly that connects the seat back to the seat base, wherein the recliner assembly includes a pair of recliner mechanisms that are disposed on opposite sides of the seat, and which may be shifted between the locked position and an unlocked position by manually pivoting a connector rod. The connecting rod is operably, but not directly, connected to at least one, and may be connected to both, of the recliner mechanisms through engagement with an extended hub at a location on the inboard side of the recliner mechanism, which hub is, in turn, engaged with the recliner mechanism.

The above aspects of the invention, and other aspects, will be better understood in view of the attached drawings and the following detailed description of the illustrated embodiment.

### BRIEF DESCRIPTION OF THE DRAWINGS

FIG. 1 is a fragmentary perspective view of a portions of a prior art vehicle seat frame;

FIG. 2 is a partial top view of a prior art disc-type recliner mechanism and connector rod assembly;

FIG. 3 is a partial top view of one embodiment of the recliner mechanism and connector rod assembly of the present invention;

FIG. 4 is a partial top cross-sectional view of the connector rod assembly shown in FIG. 3;

FIG. 5 is a perspective and enlarged view of one embodiment of an extended hub employed in the disclosed recliner assembly;

FIG. 6 is a bottom end view of the extended hub shown in FIG. 5;

FIG. 7 is a partial top view of the extended hub connected at its inboard end to one end of the connector rod, and at its outboard end to one of the recliner mechanisms;

FIG. 8 is a cross-sectional view at A-A of the connector rod assembly of FIG. 7 taken at the intersection of the outboard portion of the extended hub and the recliner mechanism; and

FIG. 9 is a cross-sectional view at B-B of the connector rod assembly of FIG. 7 taken at the intersection of the connector rod and the inboard end of the extended hub.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As previously described, FIG. 1 depicts a vehicle seat 10 including an existing recliner assembly. The vehicle seat includes seat back 12 and a seat base 14 that are connected by an inboard recliner mechanism 16 and an outboard recliner mechanism 18. The inboard recliner mechanism 16 and outboard recliner mechanism 18 are connected by a connector rod 20 that is used to coordinate release and locking of the inboard and outboard recliner mechanisms 16 and 18.

As also previously described, FIG. 2 depicts an existing disc-type recliner mechanism 18 which may be mounted on one side of a vehicle seat. A similar mechanism is typically mounted on the other side of the seat and is connected to the other recliner for common operation by a connector rod. As shown, the recliner connector rod 20 passes through an opening in the recliner heart and is retained by a clip/push nut 22. Under rear impact conditions the connector rod may deform and, in some cases, rotate, which can result in the partial release of the recliner mechanism (i.e., pawl teeth not forced into full engagement with the teeth of the gear plate).

Additional details of one type of the vehicle seat and recliner assembly depicted in FIGS. 1 and 2 may be found in United States Patent Publication No. 2012/0086253A1, the disclosure of which is hereby incorporated herein in its entirety.

FIGS. 3-9 depict one embodiment of the disclosed breakaway connector rod assembly. It will be appreciated that the disclosed breakaway connector rod assembly can be integrated into existing vehicle seats utilizing existing disc-type recliner mechanisms such as those disclosed in U.S. Pat. No. 7,878,593 and U.S. Patent Application Publication No. 2012/0086253, (each of which is incorporated in their entirety by reference herein) by substituting the connector rod, extended hub, and rod detent components of the assembly disclosed herein and illustrated in each of FIGS. 3-9.

In the illustrated embodiment, a breakaway connector rod assembly 30 includes an elongate connector rod 32, and an extended hub 34 which is connected at its inboard and outboard ends, respectively, to the connector rod and one of the recliner mechanisms 36. The outboard side 38 of the hub is shaped to fit within the opening in a manner which allows for the hub and the connector rod inserted therein to fit relatively snugly and not rotate with respect to the recliner assembly.

The inboard side 40 of the hub extends inwardly such that the connector rod 32 engages with, and frictionally fits within the opening for substantially the entire length of the inwardly extending portion of the recliner hub, but the connector rod does not pass through, and preferably does not enter, the heart of the recliner.

In the disclosed embodiment, the connector rod 32 is constrained from lateral movement by the addition of a detent, such as retainer clip 42, to the connector rod, as shown in FIG. 3, which limits the extent of the engagement of the connector rod 32 to the inboard portion 40 of the extended hub 34, and, therefore, the connector rod does not extend into or through the outboard portion of the hub or the heart of the recliner mechanism.

In an alternative embodiment (not shown), the inner opening of the outboard portion of the extended hub may be provided with either a different cross-sectional shape or a relatively narrower radial dimension than the opening of the inboard side of the hub, such that the connector rod may be slidably inserted into, and retained within, the hub at its inboard side, but the connector rod is too large or different in cross-sectional shape to fit within the opening in the outboard portion of the hub that extends into and through the heart of the recliner mechanism.

Referring now to FIGS. 5-7, each extended hub 34 includes an outboard portion 38 and an inboard portion 40. When assembled, the outboard portion 38 is inserted into an opening in the heart of one of the recliner mechanisms 36, such that the extended hub 34 is retained within, and is substantially non-rotating with respect to, the recliner mechanism 36.

The inboard portion 40 of the hub 34 has an opening defined therein suitable for inserting and connecting the connector rod 32 into the inboard portion 40, such that the connector rod is retained within, and does not rotate with respect to, the extended hub 34. Moreover, the connector rod end 32 thus extends into the inboard portion 40 of the extended hub 34, but does not extend into the outboard portion 38 of the hub 34 and, therefore, the connector rod end does not extend into or through the heart of the recliner mechanism.

The outboard end 38 of the hub 34 is substantially non-circular in cross-section. Similarly, the opening in the heart of the recliner mechanism 36 into which the outboard portion 38 extends is also substantially non-circular in cross-section and substantially similar in cross-section to the cross-section of the outboard portion 38 of the hub, such that when the hub is inserted through the heart of the recliner, the hub does not rotate to respect to the recliner mechanism. In the embodiment illustrated in FIG. 8, the outboard portion 38 of the hub includes two projecting surfaces 44 and 46 which cooperate with complementary projections in the opening of a component 50 of the recliner mechanism to prevent rotation of the hub 34 with respect to the recliner mechanism. It will be appreciated that some degree of play may be desired such that slight rotation of the connector rod/hub may be allowed without rotating component 50 of the recliner mechanism. In one embodiment, the outboard portion 38 of the hub is shaped such that the hub may be rotated at an angle of about 6° in either direction (i.e. a range of rotational movement of up to 12°) without engaging and rotating component 50 of the recliner mechanism.

Referring now to FIG. 9, the end of the connector rod 32 has a substantially non-circular cross-section which is similar to the cross-section of the opening in the inboard portion 40 of the hub 34. When assembled, the end of the connector rod fits into the opening at the inboard end of the extended hub 34 such that the connector rod is contained within and does not rotate with respect to, the extended hub 34. In this disclosed embodiment, the end of the connector rod 32 is substantially rectangular, and the opening and the inboard portion 40 of the extended hub has a similar, substantially rectangular configuration. In the disclosed embodiment, the size and shape of the end of the connector rod 32 are substantially identical to the size and shape of the opening in the inboard portion 40 of the extended hub, such that there is virtually no rotation of the connector rod 32 with respect to the hub 34. For example, in one embodiment, the tolerance for the fit of rod end with the hub opening limits rotation of the rod with respect to the hub of no more than 1° in either direction (i.e. a total range of rotational movement of 2° or less).

It will be appreciated that the shape of the connector rod ends and the complimentary opening in the inboard portion 40 of the extended hub 34 can be shaped in a variety of configurations as desired to provide a non-rotational fit between the connector rod end and the hub. It will also be appreciated that the tolerances in the shape and dimensions of the connector rod end and the inboard portion of the hub may be varied as desired to provide for disengagement of the connector rod from the hub under certain load events.

In one embodiment, the connector rod 32 is a metal tube, but would it will be appreciated that the rod may be formed of any solid or hollow material that is suitably strong enough to interconnect and operate each of the inboard and outboard recliner mechanisms in tandem. The extended hub is, in one embodiment, fabricated from rigid molded plastic. The hub 34 should be of sufficient strength and rigidity to provide a solid interconnection between each of the recliner mechanisms and the connector rod. However, the hub should also be flexible enough, particularly at its inboard end to allow the connector rod to disengage from the hub in the event of a high-impact load, such as, for example, a rear-end collision. Alternatively, the hub, and in particular, the inboard end thereof, could be fabricated to be brittle enough to breakaway and thereby cause disengagement of the connector rod 32 with the recliner mechanism 36 in the event of such a high-impact load.

In one embodiment, the disclosed vehicle seat including the breakaway connector rod assembly comprises 30 a seat back 12, a seat base 14, and a hinge assembly that connects the seat back to the seat base, wherein the hinge assembly includes a pair of recliner mechanisms 36 that are disposed on opposite sides of the seat, and which may be shifted between the locked position and an unlocked position by manually pivoting a connector rod 32. The connecting rod 32 is operably, but not directly, connected to at least one, and may be connected to both, of the recliner mechanisms 36 through engagement with an extended hub 34 at a location on the inboard side of the recliner mechanism, which hub 34 is, in turn, engaged with the recliner mechanism.

In another embodiment, the disclosed recliner assembly including the breakaway connector rod assembly comprises a first extended hub 34 adapted to operatively fit in the central opening at the heart of a first recliner mechanism 36 located at the outboard side of the seat, and a connector rod 32 which is operatively engaged at one end within the inboard portion of the hub 34 such that the connector rod end extends into the inboard portion, but not into the opening in the recliner mechanism (as described above). The assembly further includes a second extended hub adapted to operatively fit in the central opening at the heart of a second recliner mechanism located at the inboard side of the seat, wherein the connector rod 32 is operatively engaged at its opposite end within the inboard portion 40 of the second hub such that the connector rod end extends into the inboard portion 40, but not into the opening in the second recliner mechanism (again as described above). The first recliner mechanism and the second recliner mechanism are thereby operably connected through the connections of (i) the first extended hub 34 with the first recliner mechanism 36, (ii) the first extended hub 34 with one end of the connector rod 32, (iii) the other end of the connector rod with the second extended hub, and (iv) the second extended hub with the second recliner mechanism.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seat comprising:
a seat base;
a seat back attached to the seat base;
a pair of recliner mechanisms disposed on opposite sides of the seat for connecting the seat back to the seat base, wherein each recliner mechanisms has a pivoting part and a stationary part that are each associated with one of the seat back and seat base, and wherein each of the pair of recliner mechanisms may be shifted between a locked position and an unlocked position; and
a connector rod assembly for connecting the pair of recliner mechanisms such that the pair of recliner mechanisms may simultaneously be shifted from the locked to unlocked positions to facilitate rotation of the seat back with respect to the seat base, the connector rod assembly including,
a connector rod operably, but not directly, connected to each of the pair of recliners,
a first hub including an outboard portion engaged with one of the pair of recliners, and an inboard portion connected to one end of the connector rod, and
a second hub including an outboard portion engaged with the other one of the pair of recliners, and an inboard portion connected to the other end of the connector rod,
wherein the outboard portion of each of the first and second hubs is configured to be engaged with, and substantially non-rotating with respect to, each of the recliner mechanisms to which the hubs are engaged, wherein the inboard portion of each of the first and second hubs has an opening extending into at least the inboard portion of the hub along the longitudinal axis of the hub, and wherein each end of the rod is configured to be inserted into the opening in the inboard portion of each of the first and second hubs such that the connector rod is retained within, and does not rotate with respect to, the hubs.

2. The vehicle seat of claim 1 wherein the outboard portion of each of the first and second hubs is substantially non-circular in cross-section, and wherein each of the pair of recliner mechanisms includes an opening having a non-circular cross-section that is substantially similar to the cross-section of the outboard portions of the hubs, suitable for inserting and engaging the outboard portions of each one of the first and second hubs, respectively, into each of one and the other of the pair of recliner mechanisms such that each of the first and second hubs are, respectively, retained within, and are substantially non-rotating with respect to, each the portion of the recliner mechanisms to which the hubs are engaged, and
wherein the connector rod is a tubular member having a substantially non-circular cross-section at each end, and wherein the inboard portion of each of the first and second hubs has an opening extending though the hub along the longitudinal axis of the hub and having a substantially similar non-circular cross-section suitable for inserting and connecting an end of the connector rod into the inboard portion of the hub such that the connector rod is retained within, and does not rotate with respect to, the hub, and wherein the end of the connecting rod which extends into the opening in the hub does not extend completely through the opening in the recliner mechanism with which the hub is engaged.

3. The vehicle seat of claim 2 wherein the outboard portion of each of the first and second hubs and the openings in each of the recliners are substantially rectangular in cross-section.

4. The vehicle seat of claim 2 wherein each end of the connector rod and the openings in the inboard portion of each of the first and second hubs are substantially rectangular in cross-section.

5. The vehicle seat of claim 2 wherein the ends of the connecting rod do not extend into the openings in the recliners.

6. The vehicle seat of claim 2 wherein the ends of the connecting rod do not extend into the outboard portions of the hubs.

7. The vehicle seat of claim 2 wherein the connector rod assembly further includes at least one retainer clip attached at one end of the connector rod adjacent the inboard portion of the hub to which the end is connected such that the connector rod is restrained from entering the outboard portion of the hub.

8. The vehicle seat of claim 2 wherein the opening in the outboard portion of the hub is configured such that the connector rod end does not fit into the opening in the outboard portion of the hub.

9. A recliner assembly for a vehicle seat having a seat base and a seat back, the recliner assembly comprising:
a pair of adjustable recliners disposed on opposite sides of the seat for connecting the seat back to the seat base, wherein each recliner has a pivoting part and a stationary part that are each associated with one of the seat base and seat back, and wherein each of the pair of recliners are shifted between a locked position and an unlocked position; and
a connector rod assembly for connecting the pair of recliner mechanisms such that the pair of recliner mechanisms may simultaneously be shifted from the locked to unlocked positions to facilitate rotation of the seat back with respect to the seat base, the connector rod assembly including,
a connector rod operably, but not directly, connected to each of the pair of recliners,
a first hub including an outboard portion engaged with one of the pair of recliners, and an inboard portion connected to one end of the connector rod, and
a second hub including an outboard portion engaged with the other one of the pair of recliners, and an inboard portion connected to the other end of the connector rod,
wherein the outboard portion of each of the first and second hubs is configured to be engaged with, and substantially non-rotating with respect to, each of the recliner mechanisms to which the hubs are engaged, wherein the inboard portion of each of the first and second hubs has an opening extending into at least the inboard portion of the hub along the longitudinal axis of the hub, and wherein each end of the rod is configured to be inserted into the opening in the inboard portion of each of the first and second hubs such that the connector rod is retained within, and does not rotate with respect to, the hubs.

10. The recliner assembly of claim 9 wherein the outboard portion of each of the first and second hubs is substantially non-circular in cross-section, and wherein each of the pair of recliner mechanisms includes an opening having a non-circular cross-section that is substantially similar to the cross-section of the outboard portions of the hubs, suitable for inserting and engaging the outboard portions of each one of the first and second hubs, respectively, into each of one and the other of the pair of recliner mechanisms such that each of the first and second hubs are, respectively, retained within, and are substantially non-rotating with respect to, each the portion of the recliner mechanisms to which the hubs are engaged, and
wherein the connector rod is a tubular member having a substantially non-circular cross-section at each end, and wherein the inboard portion of each of the first and second hubs has an opening extending though the hub along the longitudinal axis of the hub and having a substantially similar non-circular cross-section suitable for inserting and connecting an end of the connector rod into the inboard portion of the hub such that the connector rod is retained within, and does not rotate with respect to, the hub, and wherein the end of the connecting rod which extends into the opening in the hub does not extend completely through the opening in the recliner mechanism with which the hub is engaged.

11. The recliner assembly of claim 10 wherein the outboard portion of each of the first and second hubs and the openings in each of the recliners are substantially rectangular in cross-section.

12. The recliner assembly of claim 10 wherein each end of the connector rod and the openings in the inboard portion of each of the first and second hubs are substantially rectangular in cross-section.

13. The recliner assembly of claim 10 wherein the ends of the connecting rod do not extend into the openings in the recliners.

14. The recliner assembly of claim 10 wherein the ends of the connecting rod do not extend into the outboard portions of the hubs.

15. The recliner assembly of claim 10 wherein the connector rod assembly further includes at least one retainer clip attached at one end of the connector rod adjacent the inboard portion of the hub to which the end is connected such that the connector rod is restrained from entering the outboard portion of the hub.

16. The recliner assembly of claim 10 wherein the opening in the outboard portion of the hub is configured such that the connector rod end does not fit into the opening in the outboard portion of the hub.

17. A recliner assembly for a vehicle seat having a seat base and a seat back, the recliner apparatus comprising:
a pair of adjustable recliners disposed on opposite sides of the seat for connecting the seat back to the seat base, wherein each recliner has a pivoting part and a stationary part that are each associated with one of the seat base and seat back, wherein each of the pair of recliners are shifted between a locked position and an unlocked position and wherein each of the pair of recliners includes an opening having a substantially rectangular cross-section; and
a connector rod assembly for connecting the pair of recliners such that the pair of recliners may simultaneously be shifted from the locked to unlocked positions to facilitate rotation of the seat back with respect to the seat base, the connector rod assembly including,
a connector rod operably, but not directly, connected to each of the pair of recliners, wherein the connector rod is a tubular member having a substantially rectangular cross-section at each end,
a first hub including an outboard portion connected to one of the pair of recliners, and an inboard portion connected to one end of the connector rod, and
a second hub including an outboard portion connected to the other one of the pair of recliners, and an inboard portion connected to the other end of the connector rod,
wherein the outboard portion of each of the first and second hubs is substantially rectangular in cross-section and substantially similar to the cross-section of the openings in the recliners such that each of the first and second hubs are, respectively, retained within, and are substantially non-rotating with respect to, each of the recliners, and
wherein the inboard portion of each of the first and second hub has an opening defined as a substantially rectangular cross-section substantially similar to the ends of the connector rod and suitable for inserting and connecting one end of the connector rod into the inboard portion of each hub such that the connector rod is retained within, and does not rotated with respect to, the hub, and wherein the ends of the connecting rod do not extend completely through the openings in the recliners.
